(19) United States
(12) Patent Application Publication
(10) Pub. No.: US 2012/0186461 A1
(43) Pub. Date: Jul. 26, 2012

(54) ROTISSERIE GRILL

(76) Inventor: AUBREY BLAKE CARSON, Memphis, TN (US)

(21) Appl. No.: 13/354,234

(22) Filed: Jan. 19, 2012

Related U.S. Application Data
(60) Provisional application No. 61/434,590, filed on Jan. 20, 2011.

(51) Int. Cl. A47J 37/04

(52) U.S. Cl. 99/421 H

(57) ABSTRACT

A rotisserie grill with multiple skewers extending forward from the back of the grill. The skewers may be presented at different heights, and are mechanically connected so as to turn together. The skewers may rotate at the same speed or different speeds. The grill may be embodied as a folding, portable grill with legs, but also may be constructed in a non-folding or non-portable form.

This application claims benefit of and priority to U.S. Provisional Application No. 61/434,590, filed Jan. 20, 2011, by Aubrey Blake Carson, and is entitled to that filing date for priority. The specification, figures and complete disclosure of U.S. Provisional Application No. 61/434,590 are incorporated herein by specific reference for all purposes.

### FIELD OF INVENTION

This invention relates to a rotisserie grill. More particularly, this invention relates to a portable rotisserie grill with multiple forward-extending skewers.

### BACKGROUND OF INVENTION

A variety of grills or barbeque devices are well known in the prior art. Several variations of collapsible or portable grill assemblies also are known. Examples of such grills are disclosed in U.S. Pat. Nos. 7,237,548; 7,051,649; 6,802,308; 6,546,845; 6,439,111; 6,205,912, 6,314,955; 5,575,195; 5,687,704; 5,103,799; and 4,878,476; the complete specifications, drawings and disclosures of which are incorporated herein in their entireties by specific references for all purposes. Food items are placed on flat grills, which require that the item be turned, or on rotisseries, which turn the food item while being cooked. A collapsible rotisserie and grill and oven combination is disclosed in U.S. Pat. No. 6,546,845. It is limited, however, to a single spit extending horizontally over the heat source, thereby limiting use of the rotisserie function, requiring changes in the heat source to vary the amount of heat being applied to the food item being cooked and making it difficult to place and remove food items.

Accordingly, what is needed is a portable grill that allows for the convenient placement and cooking of multiple food items simultaneously at varying heat levels in a rotisserie style.

### SUMMARY OF INVENTION

In various embodiments, the present invention comprises a rotisserie grill with multiple skewers extending forward from the back of the grill. The skewers may be presented at different heights, and are mechanically connected so as to turn together. The grill may be embodied in a folding, portable form with legs, but also may be constructed in a non-folding or non-portable form.

In one portable embodiment, the grill case comprises an upper and lower housing. The upper housing and lower housing are hingedly connected at the back, so as to fold like a suitcase into a compact portable form with all or the majority of the grill components stored inside. The front of the housings may be fastened together by means of one or more latches or similar devices. A handle may be provided for easy handling and transport of the case when folded.

The upper housing contains a motor and gear assembly, which is contained between the outer upper housing and the inner upper housing. The motor assembly may be battery-powered, plugged into a source of electricity, solar powered, hand-cranked, or powered by any other motive force. The motor assembly may be mechanically connected via a drive gear to a plurality of main gears. The main gears may be positioned to directly engage each other in a row, and multiple rows may be mechanically connected via a stepping gear. The rotational speed of each of the main gears thus may be equal to or vary from the other main gears. In one embodiment, stepping gears may be used in a row so that one or more gears in a row may rotate at different speeds. Similarly, while the main gears may be the same size, main gears of different radii may be used.

A gear axis extends from the center of each main gear, and is affixed thereto so as to rotate as the gear rotates. The gear axes extend through holes in one or more support shafts, with skewer hubs affixed to the ends. The hubs may be removably affixed to the shafts. In an alternative embodiment, the gear axes may rest in slots or grooves in the support shafts. The axes may extend through the inner top housing, with the hubs located on the other side of the inner top housing from the main gears and motor assembly.

When the upper housing is raised into the fully expanded position, one or more skewer assemblies, typically loaded with one or more food items (such as by piercing), may be attached to the motor and gear assembly by inserting the skewer tip into a hub. In one embodiment, the skewer tip is flattened and fits snugly within a slot or receptacle on the inside of a hub. Other shapes may be used for the skewer tip and hub slot, such as crosses, stars, or the like, as long as the hub translates rotation to the skewer. The rotation of the corresponding main gear causes the hub, and thus the skewer, to rotate.

In one embodiment, an exemplary skewer assembly comprises a skewer blade with a skewer handle at one end, opposite the skewer tip. The skewer handle may be integral with the skewer handle, or may be separately attached. The handle may be removably attached to the skewer blade, such as by a screw or rod on one piece inserted or screwed into a corresponding opening on the other piece.

The inner lower housing comprises the area where the heating element is placed to cook the food placed on the skewers. The heating element may comprise charcoal or other similar material placed in the bottom of the grill, an electric heating element, a propane or gas-powered element, or other element known in the art for cooking on grills.

The grill may be supported during use by a plurality of legs. In one exemplary embodiment, four legs are used, removably attached to the bottom of the grill (i.e., the outside of the lower housing). The legs may be telescoping, folding or comprise multiple parts (in order to be removed and placed inside the case when folded). The legs may extend at angles from the bottom. For portable embodiments, any means of removably attaching the legs known in the art may be used. The legs may be removably attached to a boss insert, such as being inserted into the open receiving end of the boss and subsequently locked in place with a locking pin. The boss insert may be threaded at the opposite end, and attached by screwing (or other means) to appropriate holes or receivers in the bottom of the grill.

When the grill is opened, a front framework is raised or inserted along the front of the grill. In one embodiment, there are horizontal support bars extending along the framework at heights to match the rows of hubs in the upper housing, thereby providing support for the skewers along that row. The support bars may contain grooves or indentations at the appropriate locations to hold the skewer in place while it rotates. The hubs may be adapted so as to allow the skewers some movement while being inserted, so that the handle end of a skewer can be raised above the framework support bar while being inserted.

Side shields also may be inserted along one or both sides of the grill. It will be appreciated that the front framework and side shields may be hingedly attached to the edges of the lower housing, and thereby be folded into the interior of the case when closed. Alternatively, one or all may be removably attached to the lower housing, and simply laid inside the interior of the case along with other components (e.g., legs).

### DESCRIPTION OF THE DRAWINGS

FIG. 1 shows a perspective view of a portable rotisserie grill in accordance with an embodiment of the present invention.

FIG. 2 shows a cutaway back view of the grill of FIG. 1.

FIG. 3 shows an enlarged side view of the hinge of the grill of FIG. 1.

FIG. 4 shows another perspective view of the grill of FIG. 1.

FIG. 5 shows an exploded view of the gear and skewer hub assembly of the grill of FIG. 1.

FIG. 6 shows an exploded view of a skewer of the grill of FIG. 1.

FIG. 7 shows an exploded view of the leg assembly of the grill of FIG. 1.

FIG. 8 shows a top view of the grill of FIG. 1.

FIG. 9 shows a bottom view of the grill of FIG. 1.

FIG. 10 shows a front view of the grill of FIG. 1.

FIG. 11 shows a back view of the grill of FIG. 1.

FIG. 12 shows a right side view of the grill of FIG. 1.

FIG. 13 shows a left side view of the grill of FIG. 1.

### DETAILED DESCRIPTION OF EXEMPLARY EMBODIMENTS

In various embodiments, the present invention comprises a rotisserie grill with multiple skewers extending forward from the back of the grill. The skewers may be presented at different heights, and are mechanically connected so as to turn together. While a folding, portable embodiment of the invention is described below, it will be appreciated that a grill in accordance with the present invention may be constructed in a non-folding or non-portable form.

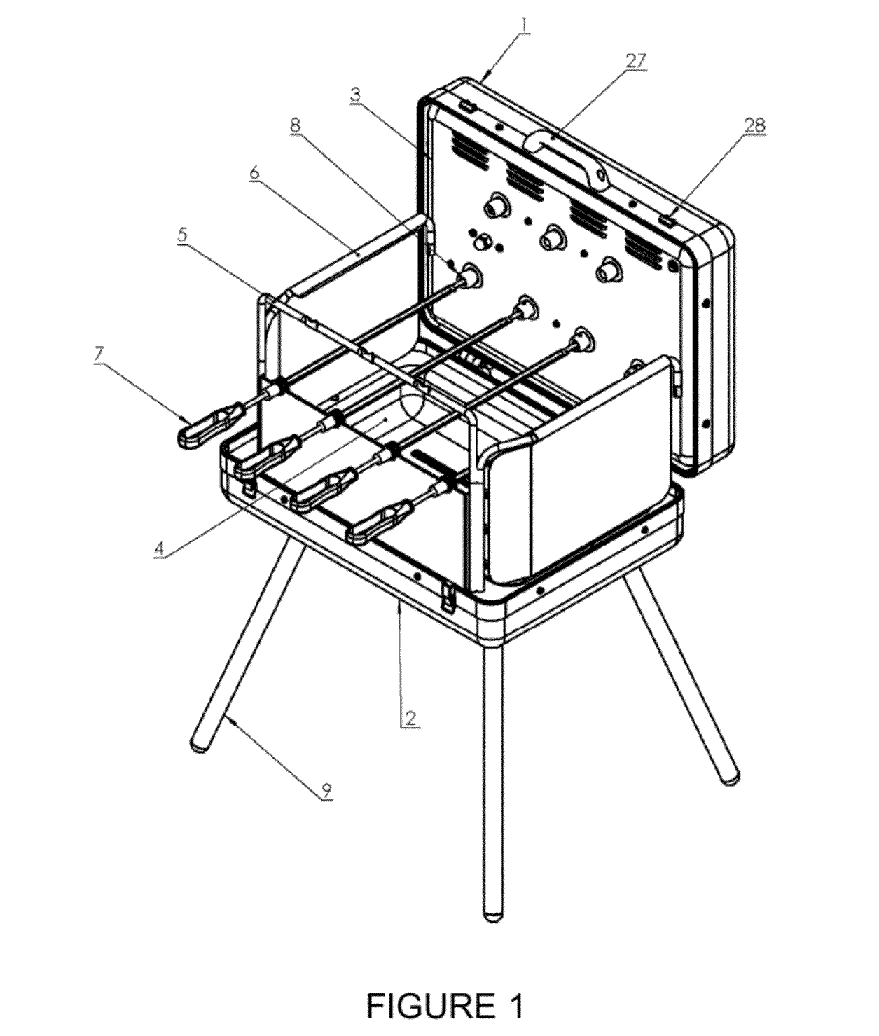

As seen in FIG. 1, the grill case comprises an upper housing 1 and lower housing 2. The upper housing and lower housing are hingedly connected at the back, so as to fold like a suitcase into a compact portable form with all or the majority of the grill components stored inside. The front of the housings may be fastened together by means of one or more latches 28 or similar devices. A handle 27 may be provided for easy handling and transport of the case when folded.

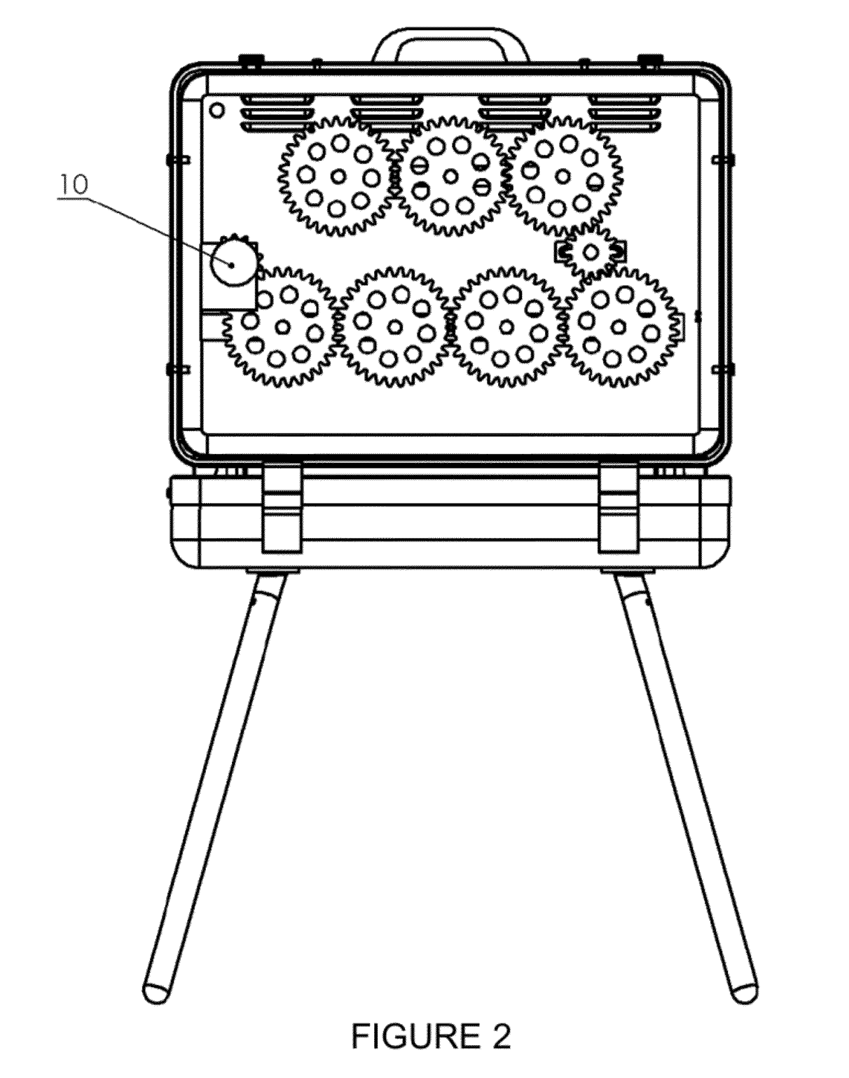

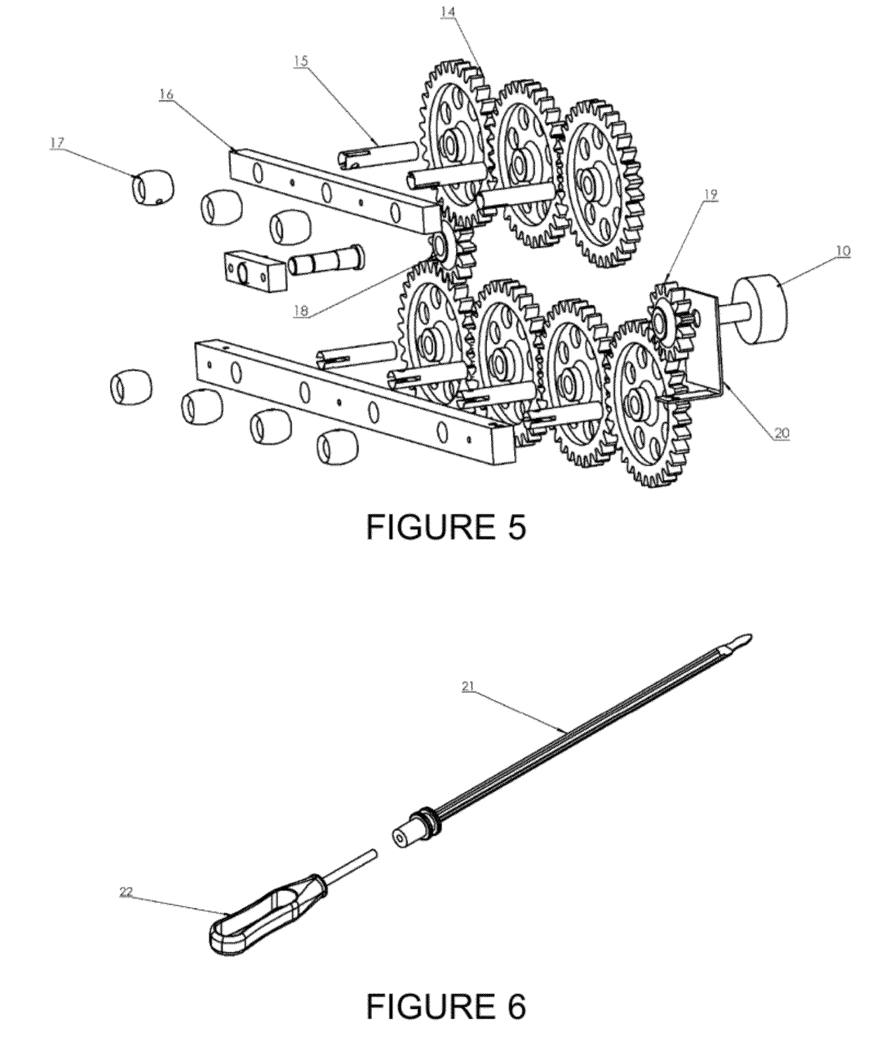

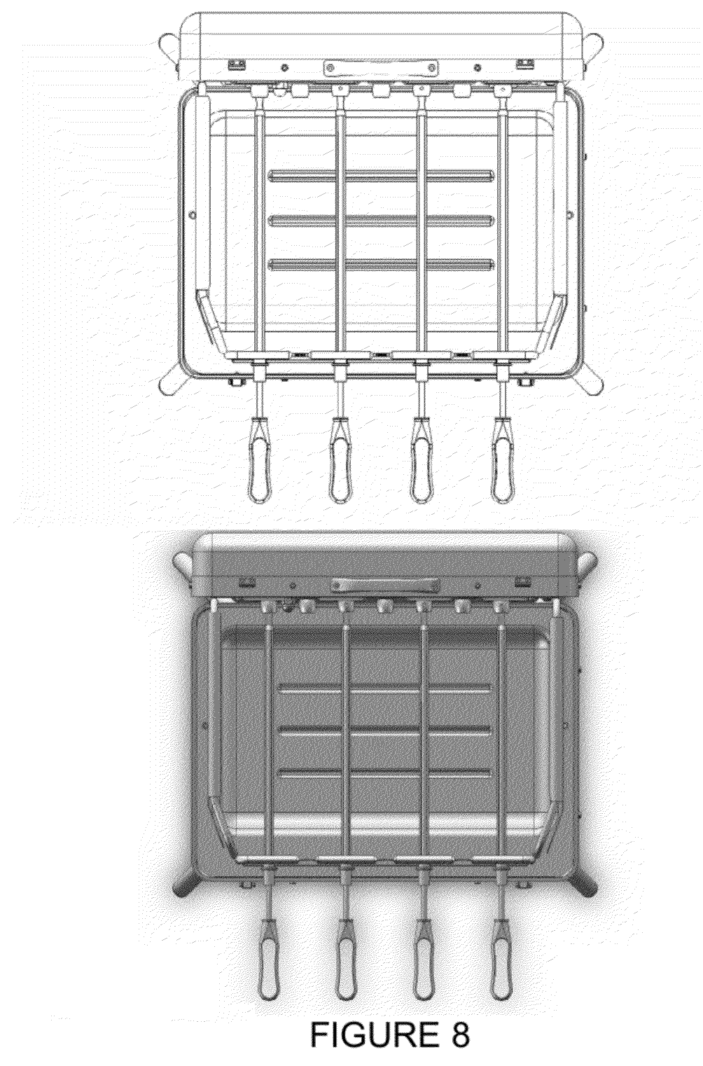

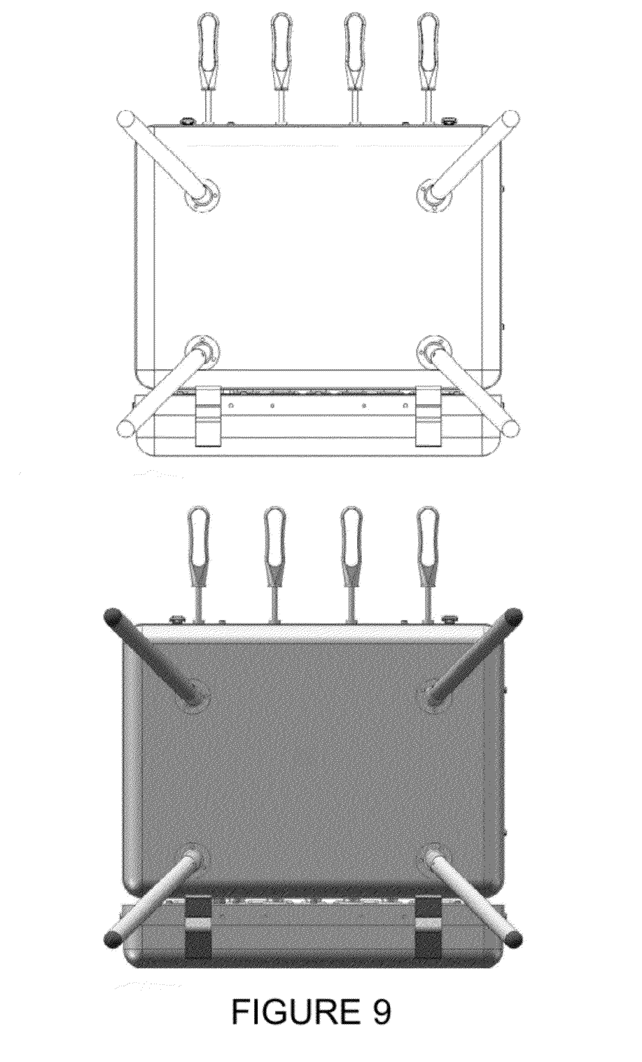

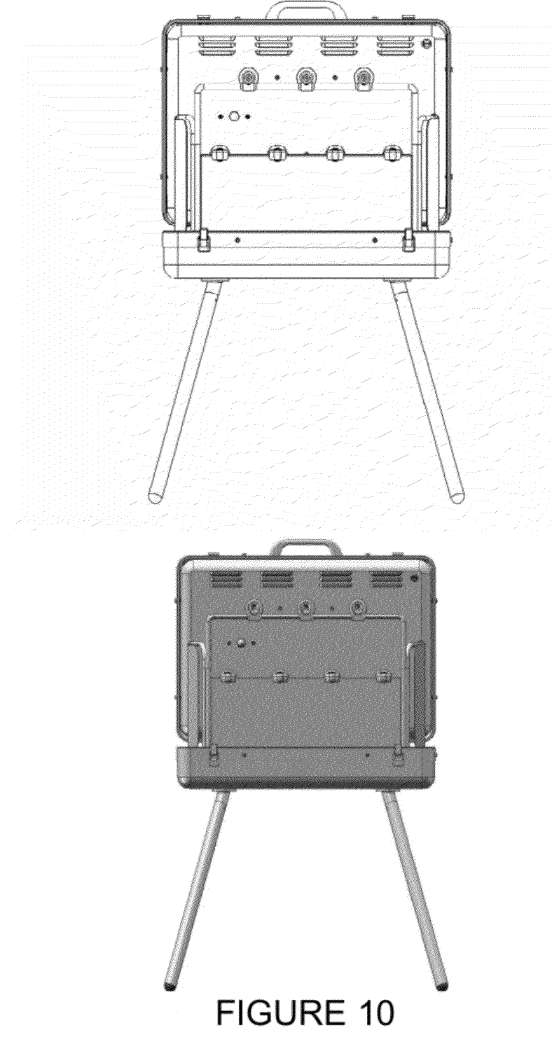

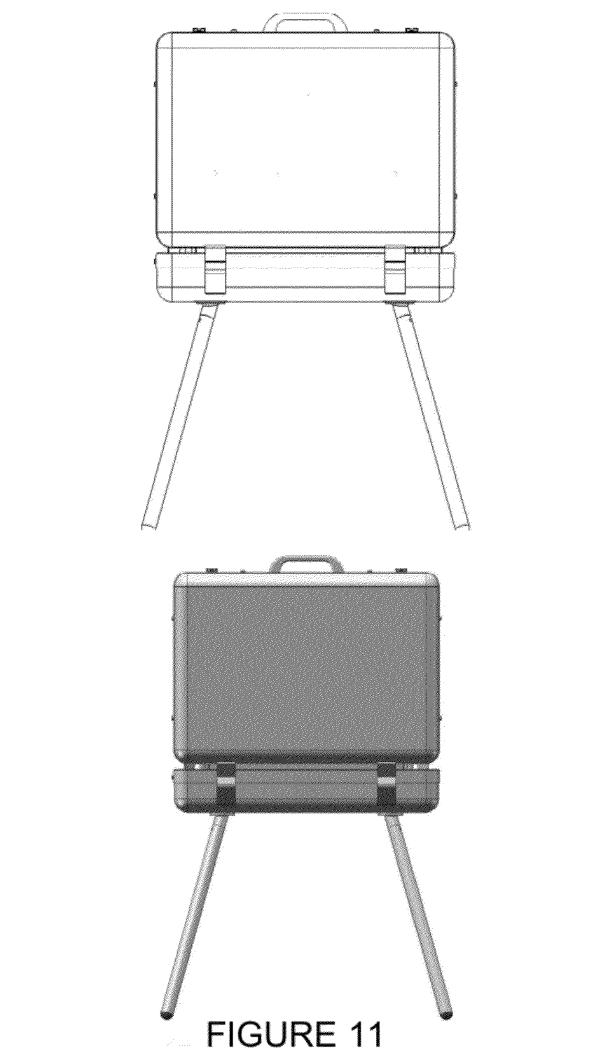

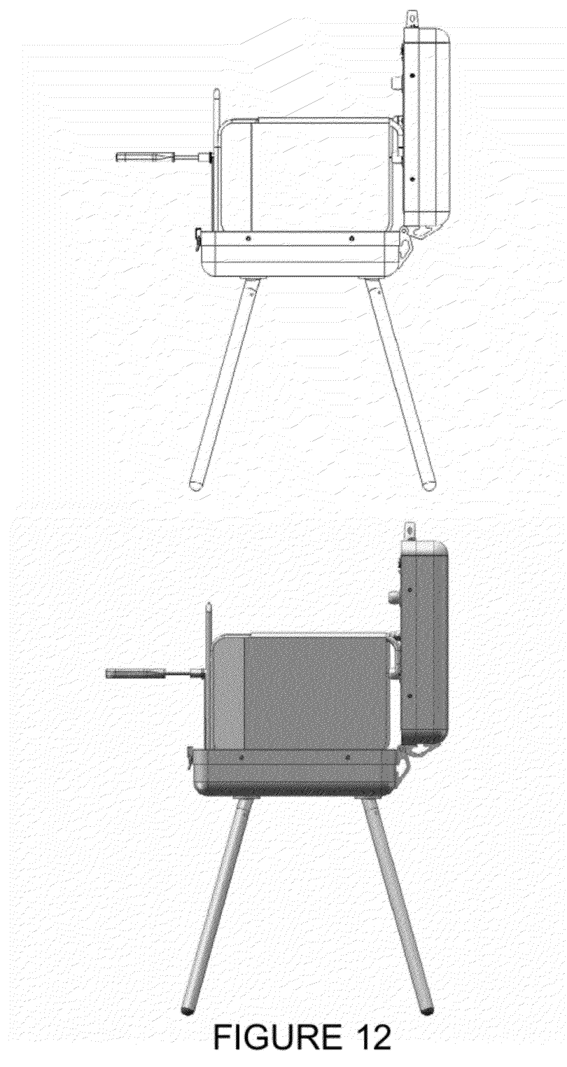

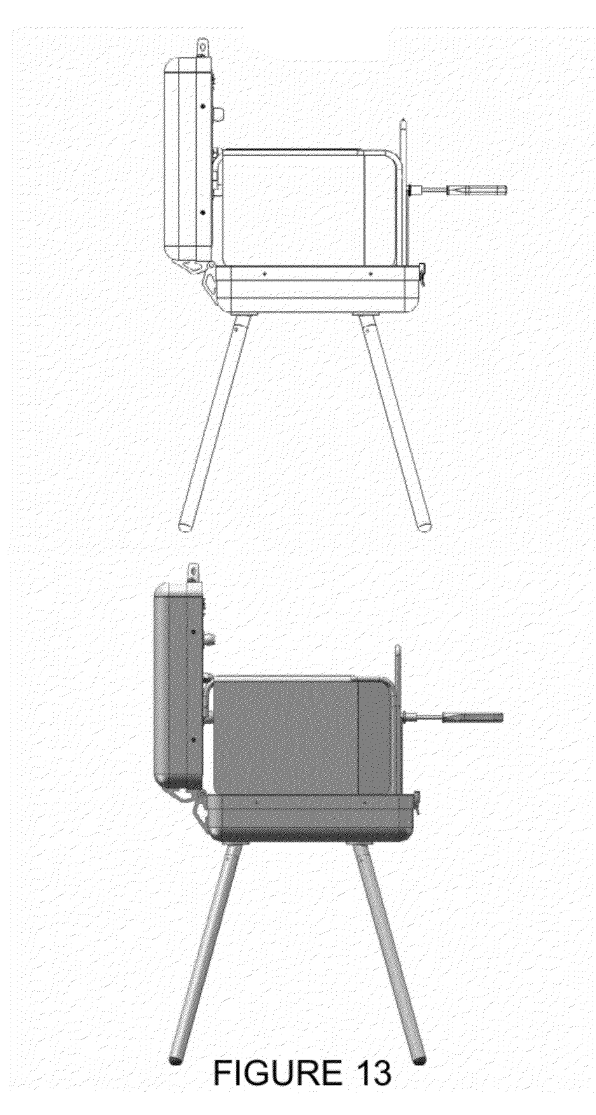

The upper housing contains a motor 10 and gear 14 assembly, which is contained between the outer upper housing and the inner 3 upper housing. The motor assembly may be battery-powered, plugged into a source of electricity, solar powered, hand-cranked, or powered by any other motive force. As seen in FIGS. 2 and 5, the motor assembly 10 is mechanically connected via a drive gear 19 to a plurality of main gears 14. The main gears may be positioned to directly engage each other in a row, and multiple rows may be mechanically connected via a stepping gear 18. The rotational speed of each of the main gears thus may be equal to or vary from the other main gears. In one embodiment, stepping gears may be used in a row so that one or more gears in a row may rotate at different speeds. Similarly, while the main gears in FIG. 5 are shown as being the same size, main gears of different radii may be used.

A gear axis 15 extends from the center of each main gear 14, and is affixed thereto so as to rotate as the gear rotates. The gear axes extend through holes in one or more support shafts 16, with skewer hubs 8, 17 affixed to the ends. The hubs may be removably affixed to the shafts. In an alternative embodiment, the gear axes may rest in slots or grooves in the support shafts 16. As seen in FIG. 1, the axes extend through the inner top housing with the hubs 8 located on the other side of the inner top housing from the main gears and motor assembly.

When the upper housing is raised into the fully expanded position, as seen in FIG. 1, one or more skewer assemblies 7, typically loaded with one or more food items (such as by piercing), may be attached to the motor and gear assembly by inserting the skewer tip 40 into a hub 8. As shown in FIG. 6, in one embodiment the skewer tip 40 is flattened and fits snugly within a slot or receptacle on the inside of a hub 8. Other shapes may be used for the skewer tip and hub slot, such as crosses, stars, or the like, as long as the hub translates rotation to the skewer. The rotation of the corresponding main gear causes the hub, and thus the skewer, to rotate.

As shown in FIG. 6, an exemplary skewer assembly comprises a skewer blade 21 with a skewer handle 22 at one end, opposite the skewer tip 40. The skewer handle may be integral with the skewer handle, or may be separately attached. In one embodiment, the handle may be removably attached to the skewer blade, such as by a screw or rod on one piece inserted or screwed into a corresponding opening on the other piece.

The inner lower housing 4 comprises the area where the heating element is placed to cook the food placed on the skewers. The heating element may comprise charcoal or other similar material placed in the bottom of the grill, an electric heating element, a propane or gas-powered element, or other element known in the art for cooking on grills.

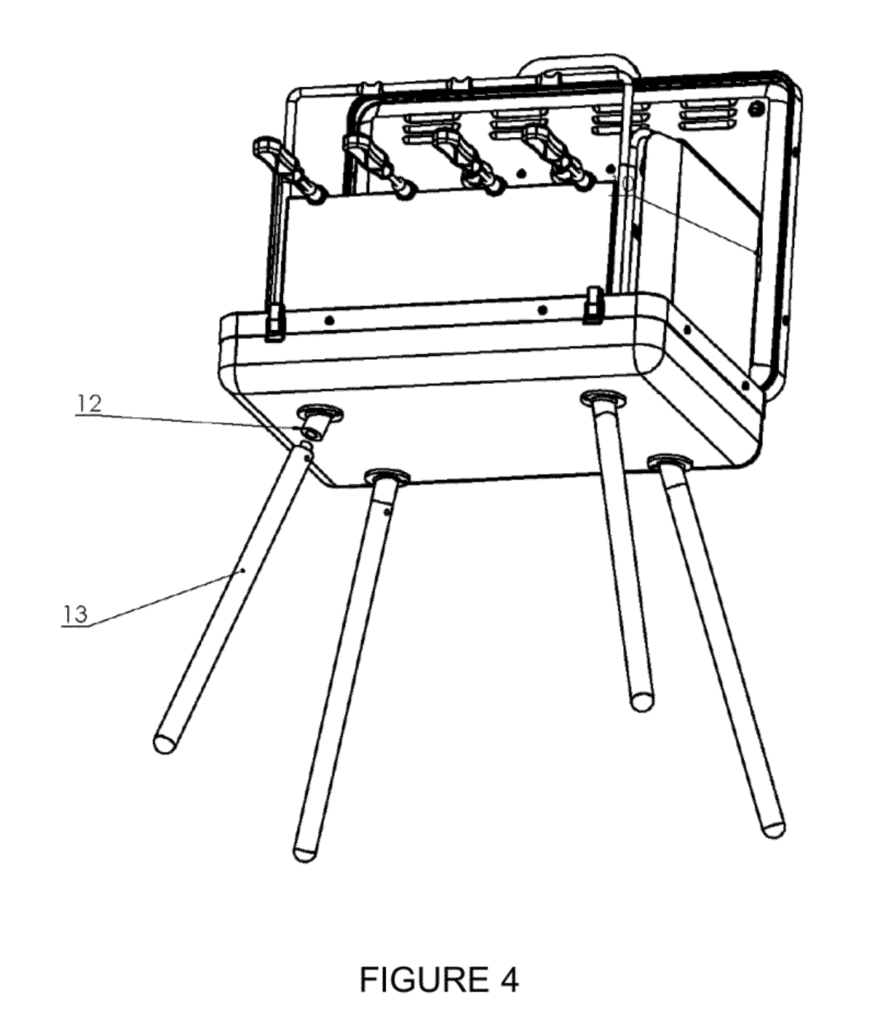

The grill is supported during use by a plurality of legs 9. In one exemplary embodiment, four legs are used, removably attached to the bottom of the grill (i.e., the outside of the lower housing 2). The legs may be telescoping, folding or comprise multiple parts (in order to be removed and placed inside the case when folded). The legs may extend at angles from the bottom. For portable embodiments, any means of removably attaching the legs known in the art may be used. As seen in FIGS. 4 and 7, the legs 13, 23 may be removably attached to a boss insert 12, 24, such as being inserted into the open receiving end of the boss and subsequently locked in place with a locking pin 26. The boss insert may be threaded at the opposite end, and attached by screwing (or other means) to appropriate holes or receivers in the bottom of the grill.

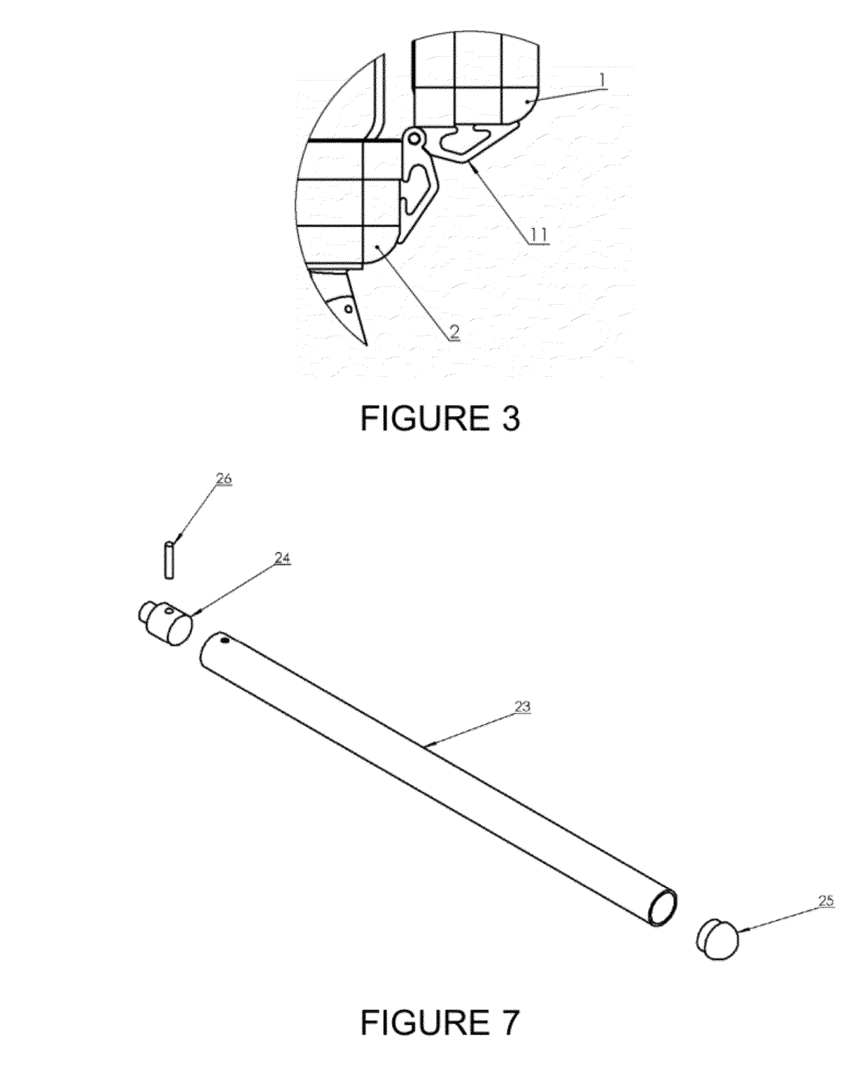

FIG. 3 shows a close-up side view of an exemplary embodiment of a self-supporting hinge assembly for a portable embodiment of the grill. The hinge assembly comprises an upper 11a and lower 11b half hingedly connected at one end. When the grill is opened, the upper half 11a rests upon and is supported by the lower half 11b.

When the grill is opened, a front framework 5 is raised or inserted along the front of the grill. In one embodiment, there are horizontal support bars extending along the framework at heights to match the rows of hubs in the upper housing, thereby providing support for the skewers along that row. The support bars may contain grooves or indentations at the appropriate locations to hold the skewer in place while it rotates. The hubs may be adapted so as to allow the skewers some movement while being inserted, so that the handle end of a skewer can be raised above the framework support bar while being inserted.

Side shields 6 also may be inserted along one or both sides of the grill. It will be appreciated that the front framework and side shields may be hingedly attached to the edges of the lower housing, and thereby be folded into the interior of the case when closed. Alternatively, one or all may be removably attached to the lower housing, and simply laid inside the interior of the case along with other components (e.g., legs).

In yet another embodiment, a grill frame may be placed over the heating element at a normal grill height (i.e., below the skewers) to catch food items from the skewers, or to allow normal grilling of food items on the grill frame.

The various embodiments described above thus provide significant advantages over the prior art. Multiple food items can be placed on different skewers and cooked simultaneously in the rotisserie style from a single heat source, with the heat level being applied varying depending on the placement of the skewer, either vertically or horizontally. The skewers have handles and can be easily inserted and removed by a user standing in front of the grill without modifying the heat source or affecting the cooking process for the food items on the other skewers. The handles of the skewers may extend beyond the front of the grill, thus allowing the user to handle the skewers without being directly exposed to the heat of the grill. Food items on different skewers can thus be at different stages in the cooking process, allowing continuous cooking as skewers with cooked items are removed and filled with new food items to be cooked. The food items may all be turn at the same speed, or at different speeds, depending on the food items. A single motor may be used, resulting in a grill that is light and portable, and that in one embodiment can be collapsed into a compact “suitcase” with one or more handles for easy carrying.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A rotisserie grill, comprising:
a grill case comprising an lower housing and an upper housing;
a heating element in the lower housing;
two or more skewers removably and rotatably connected at a tip end to corresponding rotating hubs in the upper housing, positioned so that food items placed on the skewers are rotated over the heating element.

2. The grill of claim 1, further comprising a motor assembly mechanically connected to the rotating hubs.

3. The grill of claim 2, wherein the motor is powered by a battery or electrical power supply.

4. The grill of claim 1, wherein the motor is solar powered.

5. The grill of claim 2, wherein the motor assembly is mechanically connected via a plurality of motors to the rotating hubs.

6. The grill of claim 1, wherein the rotating hubs rotate simultaneously.

7. The grill of claim 1, wherein the rotating hubs rotate at the same speed.

8. The grill of claim 1, wherein some of the rotating hubs rotate at different speeds or in different directions.

9. The grill of claim 1, wherein the rotating hubs are set at the same height from the heating element.

10. The grill of claim 1, wherein some of the rotating hubs are set at different heights from the heating element.

11. The grill of claim 1, the upper housing and lower housing are hingedly connected along their respective back edges, so as to fold together to form a portable storage case for the grill and components in a collapsible form.

12. The grill of claim 1, further comprising three or more legs.

13. The grill of claim 12, wherein the legs are removably attached to the lower housing.

14. The grill of claim 1, wherein the heating element is charcoal or wood.

15. The grill of claim 1, wherein the heating element is an electric or gas-powered heating element.

16. The grill of claim 1, wherein the skewers have a handle on the end opposite the tip.

17. The grill of claim 16, further comprising a front support to support the skewer proximate the handle end of the skewers.

18. The grill of claim 1, wherein there are seven rotating hubs.

19. The grill of claim 1, wherein the two or more rotating hubs are on multiple levels.

20. The grill of claim 1, wherein the skewers are adapted to receive food items inserted thereon, and can be inserted and removed from respective rotating hubs independently.
